(19) United States
(12) Patent Application Publication
(10) Pub. No.: US 2025/0239061 A1
(43) Pub. Date: Jul. 24, 2025

(54) LEARNABLE SENSOR SIGNATURES TO INCORPORATE MODALITY-SPECIFIC INFORMATION INTO JOINT REPRESENTATIONS FOR MULTI-MODAL FUSION

(71) Applicant: QUALCOMM Incorporated, San Diego, CA (US)

(72) Inventors: Varun RAVI KUMAR, San Diego, CA (US); Meysam SADEGHIGOOGHARI, Linkoping (SE); Senthil Kumar YOGAMANI, Headford (IE)

(21) Appl. No.: 18/419,417

(22) Filed: Jan. 22, 2024

(51) Int. Cl. G06V 10/80; G01S 7/4865; G01S 17/86; G01S 17/894; G01S 17/931; G06V 10/77; G06V 10/774; G06V 20/58

(52) U.S. Cl. CPC G06V 10/806; G01S 7/4865; G01S 17/86; G01S 17/894; G01S 17/931; G06V 10/7715; G06V 10/774; G06V 20/58

(57) ABSTRACT

Aspects presented herein may enable a UE to distinguish features captured by different sensors or different types of sensors. The UE extracts a set of features from each sensor of multiple sensors. The UE maps a vector to each feature in the set of features extracted from each sensor, where the vector is related to positioning information and/or a set of intrinsic parameters associated with each sensor of the multiple sensors. The UE concatenates sets of features from the multiple sensors with their corresponding embedded vectors. The UE trains a machine learning (ML) model to identify relationships between different sensors in the multiple sensors based on the concatenated sets of features and the corresponding embedded vectors; or output the concatenated sets of features and the corresponding embedded vectors for training of the ML model for identification of the relationships between the different sensors in the multiple sensors.

### TECHNICAL FIELD

The present disclosure relates generally to communication systems, and more particularly, to wireless communication involving object tracking.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus extracts a set of features from each sensor of multiple sensors. The apparatus maps a vector to each feature in the set of features extracted from each sensor, where the vector is related to at least one of: positioning information or a set of intrinsic parameters associated with each sensor of the multiple sensors. The apparatus concatenates sets of features from the multiple sensors with their corresponding embedded vectors. The apparatus trains a machine learning (ML) model to identify relationships between different sensors in the multiple sensors based on the concatenated sets of features and the corresponding embedded vectors; or outputs the concatenated sets of features and the corresponding embedded vectors for training of the ML model for identification of the relationships between the different sensors in the multiple sensors.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a UE positioning based on reference signal measurements.

FIG. 5 is a diagram illustrating an example of field-of-views (FOVs) captured by different cameras of a vehicle in accordance with various aspects of the present disclosure.

FIG. 6 is a diagram illustrating an example of cameras in a bird's eye view (BEV) grid using lift, splat, shoot (LSS) depth probabilities in accordance with various aspects of the present disclosure.

FIG. 7 is a diagram illustrating an example framework of fusing outputs from different types of sensors in accordance with various aspects of the present disclosure.

FIG. 8 is a diagram illustrating an example framework of fusing outputs from different types of sensors with sensor embeddings in accordance with various aspects of the present disclosure.

FIG. 9 is a flowchart of a method of data processing.

FIG. 10 is a flowchart of a method of data processing.

FIG. 11 is a diagram illustrating an example of a hardware implementation for an example apparatus and/or network entity.

### DETAILED DESCRIPTION

Aspects presented herein may improve the overall performance of object detection performed by multiple sensors and/or different types of sensors. Aspects presented herein may enable a UE to effectively distinguish (or train a machine learning (ML) model to effectively distinguish) features captured by different sensors or different types of sensors by configuring the UE to embed/associate/map features from each sensor before concatenating them, which may be referred to as the “sensor embedding(s)” for purposes of the present disclosure. As such, the UE may be able to distinguish the source of the features and account for sensor variability with higher accuracy. The sensor embeddings described herein may help reduce feature overlapping by assigning a unique signature to features from each sensor in the BEV grid, making it easier to identify the source of the feature. The sensor embeddings, whether fixed or learned, may be configured to encode differences in sensor characteristics like field-of-view. This may enable a UE (or a model/algorithm used by the UE) to better integrate features despite variability. In some implementations, by configuring the sensor embeddings to be conditional on a learned sensor feature vector, it may allow the embedding dimensions to vary based on location-specific factors such as the visibility and/or proximity (which may address the dependency on location). Also, the learning sensor embeddings may be tailored to each sensor's modalities and the environment in a more optimized approach than typical/current summation, and may improve feature representation and downstream task performance.

Summing up features from different cameras in the BEV projection may result in overlapping features in many cells of the BEV grid, thus making it difficult to distinguish between features captured by different cameras. The current summation approach fails to optimize the pooling operation for specific sensor characteristics or the location within the BEV, and that may impact downstream tasks utilizing the BEV feature map. Aspects presented herein may enable a UE (e.g., a vehicle that is configured to perform road object detection using multiple sensors) to embed features from each sensor before summing them so as to distinguish the source of the features and account for sensor variability. A unique signature is applied to features from each sensor in the BEV grid to identify the source. In another aspect, the sensor's intrinsic parameters (focal length, principal point, FOV, etc.) are used to identify and distinguish the sensors. In another aspect, different embedding dimensions are used for different sensor types (camera, lidar). In a further aspect, embedding dimensions are conditional on learned scene features per sensor, thus allowing for dynamic adaptation based on environment.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

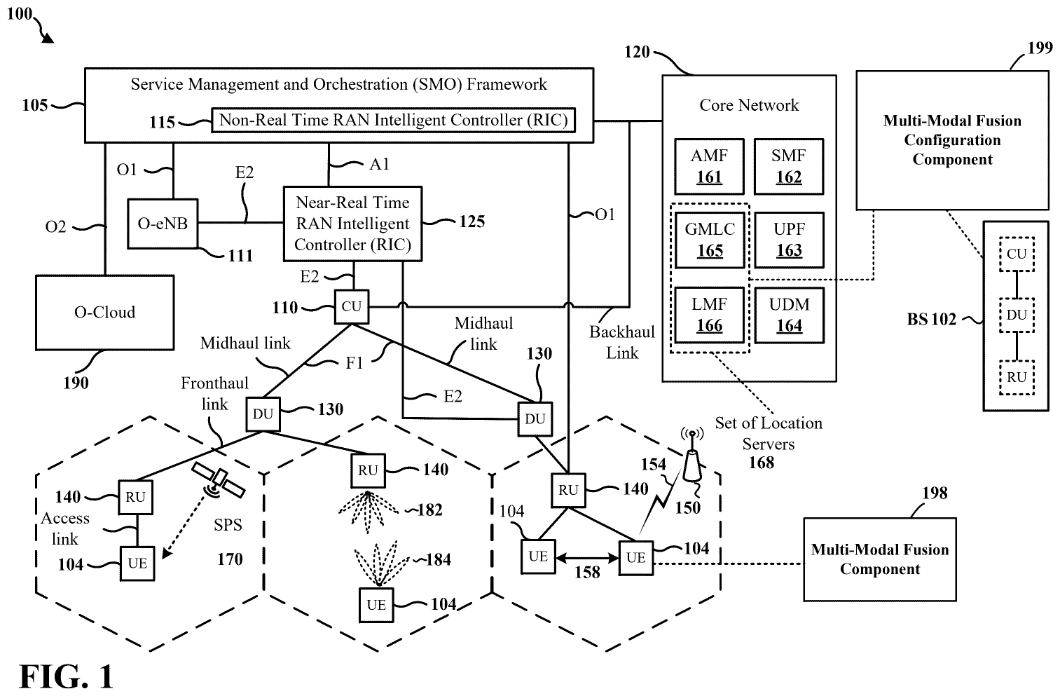

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a multi-modal fusion component 198 that may be configured to extract a set of features from each sensor of multiple sensors; map a vector to each feature in the set of features extracted from each sensor, where the vector is related to at least one of: positioning information or a set of intrinsic parameters associated with each sensor of the multiple sensors; concatenate sets of features from the multiple sensors with their corresponding embedded vectors; and train an ML model to identify relationships between different sensors in the multiple sensors based on the concatenated sets of features and the corresponding embedded vectors; or output the concatenated sets of features and the corresponding embedded vectors for training of the ML model for identification of the relationships between the different sensors in the multiple sensors. In certain aspects, the base station 102 or the one or more location servers 168 may have a multi-modal fusion configuration component 199 that may be configured to provide configurations and/or parameters related to multi-modal fusion or sensor fusion for the UE 104.

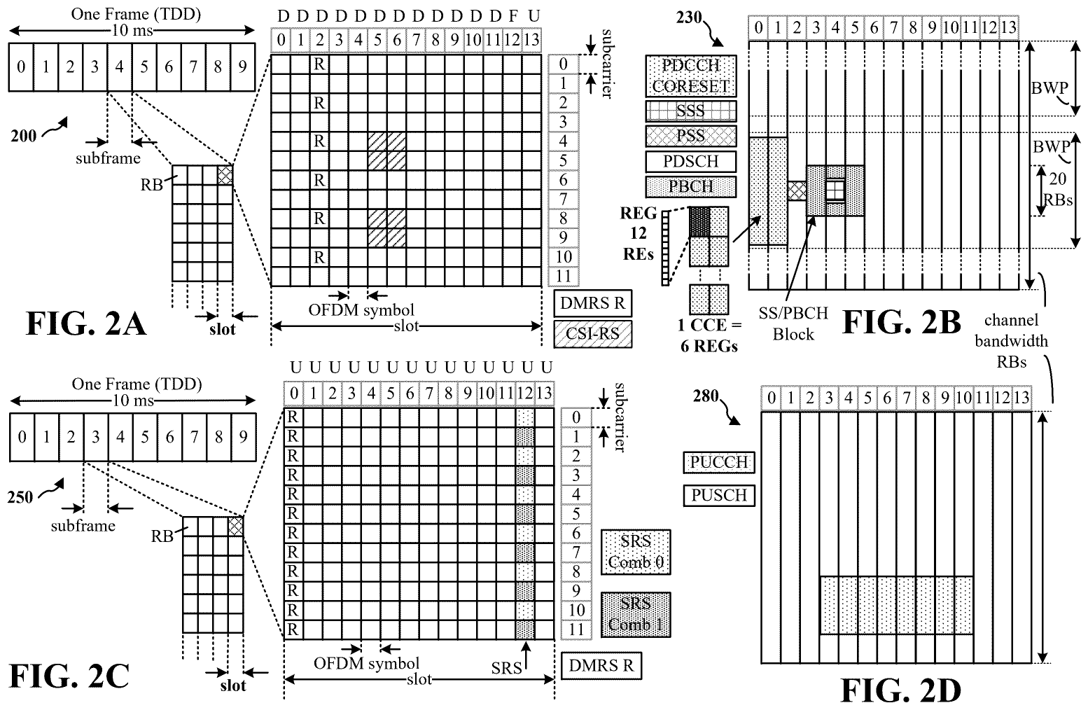

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | Cyclic |
|---|---|---|
| μ | Δf = 2^{μ} · 15[kHz] | prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

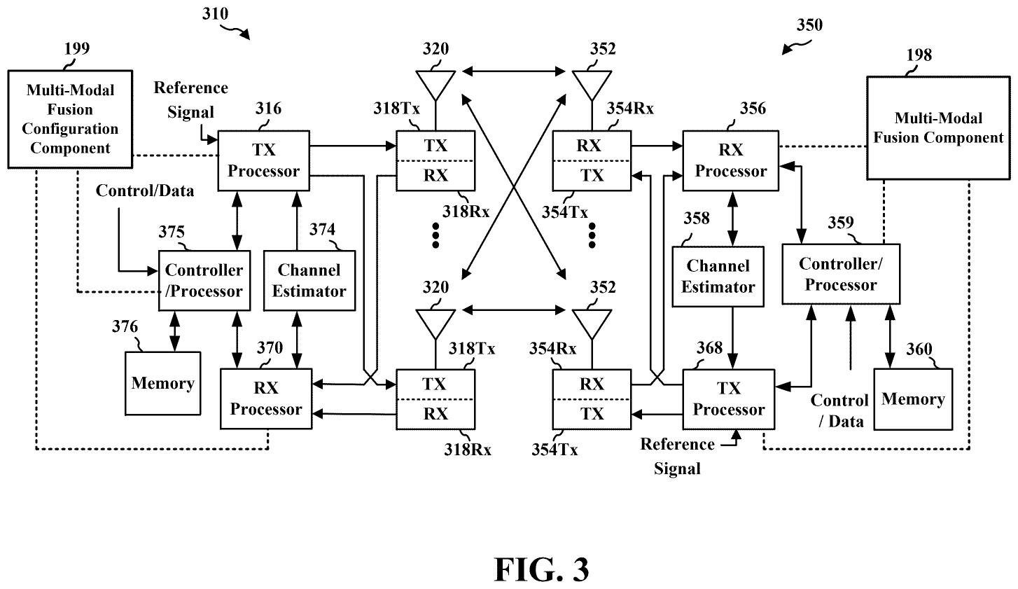

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the multi-modal fusion component 198 of FIG. 1.

At least one of the TX processor 316, the RX processor 370, and the controller/processor 375 may be configured to perform aspects in connection with the multi-modal fusion configuration component 199 of FIG. 1.

In recent years, vehicle manufacturers have been developing vehicles with assisted driving and/or autonomous driving capabilities. Assisted driving, which may also be called advanced driver assistance systems (ADAS), may refer to a set of technologies designed to enhance vehicle safety and improve the driving experience by providing assistance and automation to the driver. These technologies may use various sensor(s), such as camera(s), radar(s), light detection and ranging (lidar(s) or lidar sensor(s)), etc., and other components to monitor a vehicle's surroundings and assist the driver of the vehicle with certain driving tasks. For example, some features of assisted driving systems may include: (1) adaptive cruise control (ACC) (e.g., a system that automatically adjusts a vehicle's speed to maintain a safe following distance from the vehicle ahead), (2) lane-keeping assist (LKA) (e.g., a system that uses cameras to detect lane markings and helps keep the vehicle centered within the lane, and provides steering inputs to prevent unintentional lane departure), (3), autonomous emergency braking (AEB) (e.g., a system that detects potential collisions with obstacles or pedestrians and automatically apply the brakes to avoid or mitigate the impact), (4) blind spot monitoring (BSM) (e.g., a system that uses sensors to detect vehicles in a driver's blind spots and provides visual or audible alerts to avoid potential collisions during lane changes), (5) parking assistance (e.g., a system that assists drivers in parking their vehicles by using camera(s) and sensor(s) to help with parallel parking or maneuvering into tight spaces), and/or traffic sign recognition (e.g., camera(s) and image processing are used to recognize and display traffic signs such as speed limits, stop signs, and other road regulations on the vehicle's dashboard).

Autonomous driving, which may also be called as self-driving or driverless technology, may refer to the ability of a vehicle to navigate and operate itself without specifying human intervention (e.g., travelling from one place to another place without a human controlling the vehicle). The goal of the autonomous driving is to create vehicles that are capable of perceiving their surroundings, making decisions, and controlling their movements, all without the direct involvement of a human driver. To achieve or improve the autonomous driving, a vehicle may be specified to use a map (or map data) with detailed information, such as a high-definition (HD) map. An HD map may refer to a highly detailed and accurate digital map designed for use in autonomous driving and ADAS. In one example, HD maps may typically include one or more of: (1) geometric information (e.g., precise road geometry, including lane boundaries, curvature, slopes, and detailed 3D models of the surrounding environment), (2) lane-level information (e.g., information about individual lanes on the road, such as lane width, lane type (e.g., driving, turning, or parking lanes), and lane connectivity), (3) road attributes (e.g., data on road features like traffic signs, signals, traffic lights, speed limits, and road markings), (4) topology (e.g., information about the relationships between different roads, intersections, and connectivity patterns), (5) static objects (e.g., locations and details of fixed objects along the road, such as buildings, traffic barriers, and poles), (6) dynamic objects (e.g., real-time or frequently updated data about moving objects, like other vehicles, pedestrians, and cyclists), and/or (7) localization and positioning: precise reference points and landmarks that help in accurate vehicle localization on the map, etc.

To enable a vehicle to be capable of providing assisted driving and/or autonomous driving, the vehicle may be configured to use various machine learning (ML) and/or neural network (NN) frameworks. An ML/NN framework may refer to a set of tools, libraries, and/or software components that are configured to provide a structured way to design, build, and deploy ML/NN models and applications. These frameworks may be able to simplify the process of developing ML/NN algorithms and applications by providing a foundation of pre-built functions, algorithms, and utilities. They may typically include features for data preprocessing, model training, evaluation, and/or deployment, etc. ML/NN frameworks may come in various programming languages, and they may be configured to cater to different types of machine learning tasks, including supervised learning, unsupervised learning, and/or reinforcement learning, etc. An ML/NN model may refer to a mathematical representation of a real-world process or problem, created using ML/NN algorithms and techniques. These ML/NN models may be configured to make predictions, classify data, and/or solve specific tasks based on patterns and relationships learned from input data. A deep learning framework may refer to a specialized software library or toolset that provides specified components and abstractions for building, training, and deploying deep neural networks. Deep learning frameworks may be designed to facilitate the development of complex neural network models, especially deep neural networks with multiple layers. These frameworks may offer a wide range of pre-implemented layers, optimizers, loss functions, and other components, making it easier for researchers and developers to work with deep learning models.

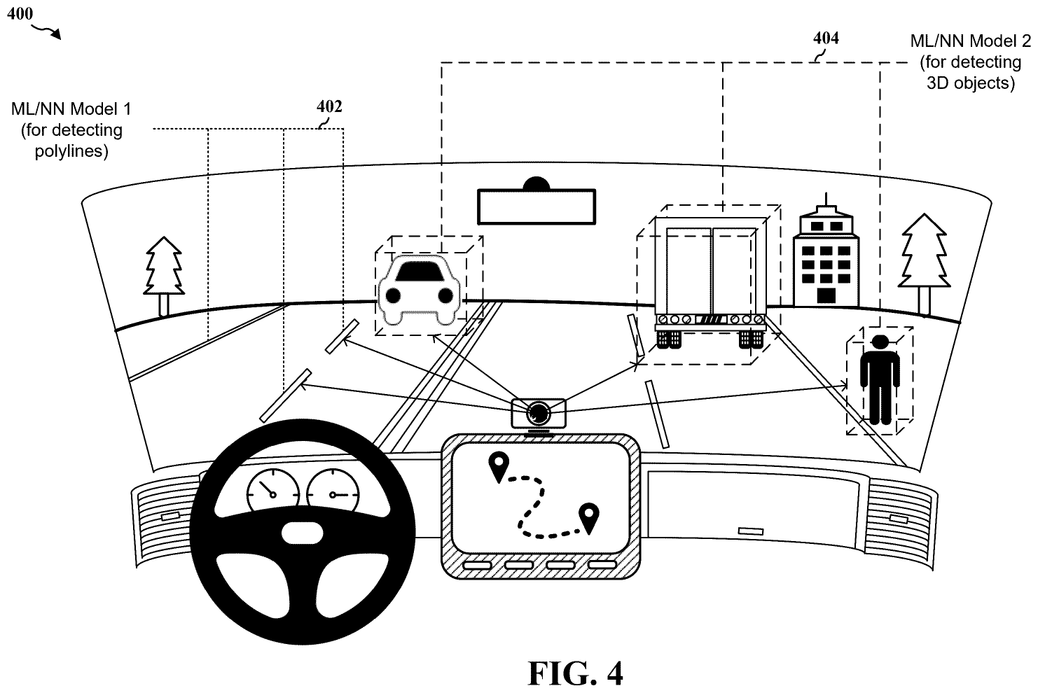

FIG. 4 is a diagram 400 illustrating an example road object detection in accordance with various aspects of the present disclosure. In some implementations, an ADAS or an autonomous driving system may be configured to perform object detections using one or more ML/NN models. For example, as shown at 402, a first ML/NN model (ML/NN Model 1) may be trained/used to detect and track polylines from sensor output(s) (e.g., images captured by the camera(s) of the vehicle, point clouds generated from radar(s)/lidar(s), etc.), while a second ML/NN model (ML/NN Model 2) may be trained/used to detect and track objects in a three-dimensional (3D) space (e.g., to perform 3D object detection (3DOD) tasks), such as shown at 404. Then, the outputs of these two ML/NN models may be processed and used by the ADAS or the autonomous driving system (e.g., for assisted/autonomous driving). In some implementations, an ML/NN model may also be configured to perform multiple types of object detections (e.g., to perform both the polyline detection and the 3D object detection). A point cloud may refer to a discrete set of data points in space, where these points may represent a 3D shape or object. In some implementations, each point position may be associated with a set of Cartesian coordinates (X, Y, Z). Point clouds may be produced by radar(s)/lidar(s) by detecting multiple points on the external surfaces of objects.

For purposes of the present disclosure, “perception data” or “autonomous perception data” may refer to the information gathered by a vehicle's sensor(s) and system(s) to understand and interpret its surroundings (e.g., for purposes of providing assisted/autonomous driving). For example, autonomous vehicles may be configured to rely on various sensors to perceive the environment and make informed decisions. These sensors may typically include one or more of: (1) lidar(s)/lidar sensor(s) which use laser beams to measure distances and create detailed 3D maps of the environment, (2) radar(s) which use radio waves to detect the presence, distance, and speed of objects around the vehicle, (3) camera(s) which capture visual data, allowing the vehicle to identify and recognize objects, road signs, lane markings, and other important visual cues, (4) ultrasonic sensors which use sound waves to detect objects in close proximity to the vehicle, (5) Global Navigation Satellite System (GNSS) which provides information about the vehicle's location, speed, and heading, contributing to overall situational awareness, and/or (6) inertial measurement unit(s) IMU(s) which measure the vehicle's acceleration and angular rate, helping to determine its position and orientation, etc. These sensors may collectively gather data about the vehicle's surroundings and create a comprehensive perception system. Then, a set of software algorithms may be implemented to analyze and interpret this perception data to make decisions, such as navigating the vehicle, avoiding obstacles, following traffic rules, and ensuring overall safety, etc. Perception data may be an important component of a sensor fusion process, where information from different sensors is combined to create a more accurate and reliable representation of the environment for the autonomous vehicle.

To enable a vehicle to be capable of providing assisted driving and/or autonomous driving, the vehicle may be configured to identify and track objects on the road (e.g., objects in proximity to the vehicle or within a threshold distance of the vehicle, etc.). For example, when a vehicle is under an autonomous driving mode, the vehicle (or its autonomous driving/tracking system) may be configured to identify objects related to roads and driving, such as other vehicles, pedestrians, traffic signs/lights, traffic/lane lines, and any objects that may typically present on the roads, etc., (collectively as “road objects” hereafter). The vehicle may perform the identification of road objects using one or more sensors, which may include camera(s), radar(s), Lidar(s), radio frequency (RF) sensing component(s), or a combination thereof. After the vehicle (or its autonomous driving/tracking system) identifies the road objects, the vehicle may be configured to track some of these road objects, such as to detect or monitor the movements of other vehicle(s) in front of and/or behind the vehicle. The tracking may enable the vehicle to make various decisions during the autonomous driving. For example, if the vehicle detects that a second vehicle from another lane is moving into the lane travelled by the vehicle, the vehicle may determine to modify (e.g., reduce or increase) its speed to keep a threshold (e.g., safe) distance from the second vehicle.

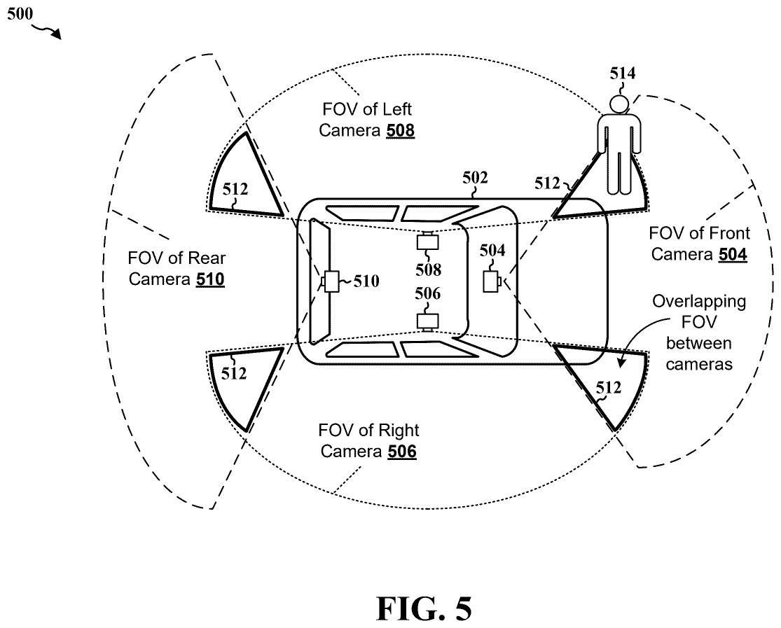

For example, a vehicle may be configured to use Lidar(s) to detect road objects by using (e.g., emitting) laser light(s) to measure the distance between the vehicle and different points/parts of the road objects. When the laser pulses hit the road objects, they may reflect back towards the Lidar(s) (and received/detected by the Lidar(s)). Then, the Lidar(s) may measure the time it takes for each laser pulse to travel from the Lidar(s) to the object and back, and use this measured time (e.g., which may be referred to as a “time of flight (ToF)”) to derive the distance between the Lidar(s) and different points of the road objects (e.g., the time of flight may be directly proportional to the distance between a reflected point and a Lidar). Then, based on the distance measurements between the Lidar(s) and different (reflected) points of the road objects, the vehicle may generate a point cloud representing the road objects. For purposes of the present disclosure, a point cloud may refer to a collection of two-dimensional (2D) and/or three-dimensional (3D) data points in space, where each point (or data point) may represent a specific point in an environment captured by a Lidar. For example, each point in the point cloud may be associated with a set of 2D coordinates (X, Y) or a set of 3D coordinates (e.g., X, Y, Z). In some examples, additional information such as color or intensity may also be included in a point cloud. FIG. 5 is a diagram 500 illustrating an example of field-of-views (FOVs) captured by different cameras of a vehicle in accordance with various aspects of the present disclosure. To detect road objects surrounding a vehicle, the vehicle may specify using multiple cameras. For example, a vehicle 502 may include a front camera 504 that is configured to capture the field-of-view (FOV) in the front of the vehicle 502, a right-side camera 506 that is configured to capture the FOV on the right-side of the vehicle 502, a left-side camera 508 that is configured to capture the FOV on the left-side of the vehicle 502, and a rear camera 510 that is configured to capture the FOV on the rear side of the vehicle 502.

In some scenarios, as shown at 512, FOVs captured by different cameras of the vehicle 502 may be overlapping. As such, a road object or its feature(s) may be captured by multiple cameras of the vehicle 502. For purposes of the present disclosure, in the context of object detection, a feature may refer to an individual measurable property or characteristic of a phenomenon being observed. Features may be the inputs used by machine learning models to make predictions or perform tasks, and they may represent the different dimensions or aspects of the data that a machine learning model uses to learn patterns and relationships. For example, as shown at 514, a pedestrian may be captured by both the front camera 504 and the left-side camera 508 of the vehicle 502. As such, some features associated with the pedestrian captured by the front camera 504 and the left-side camera 508 may be overlapping (which may be referred to as “overlapping feature(s).”

In some implementations, the vehicle 502 (or its algorithm) may be configured to combine or sum up features captured by different cameras of the vehicle 502 based on bird's eye view (BEV) projection. For purposes of the present disclosure, a BEV may refer to an elevated view of an object or a location from a steep viewing angle, creating a perspective as if the observer were a bird in flight looking downwards. For example, BEVs may be aerial photograph, and/or drawing used in the making of blueprints, floor plans and maps, etc. However, typical/current approaches of summing up features from different cameras in the BEV projection may result in overlapping features in many cells of a BEV grid. In some scenarios, this may make vehicle 502 difficult to distinguish between features captured by different cameras (e.g., the vehicle 502 may not know whether a feature on the pedestrian is from the front camera 504 or the left-side camera 508).

In addition, different cameras of the vehicle 502 may capture features with varying characteristics, which may be referred to as the sensor variability. For example, fisheye cameras (e.g., the front camera 504 and the rear camera 510) and wide cameras (e.g., the right-side camera 506 and the left-side camera 508) may provide different perspectives and levels of detail. However, the typical/current feature summation method may treat all features equally, regardless of the sensor type. Also, typical/current pooling operation for features may treat features independently of their locations in the BEV space. This may ignore the fact that certain sensors might have better visibility or capture more relevant information depending on their proximity to the car or the distance from the target object in the BEV. The typical/current summation approach may also be inefficient as it does not optimize the pooling operation for the specific sensor characteristics or the location within the BEV. This may lead to suboptimal feature representation and potentially impact the performance of downstream tasks or algorithms utilizing the BEV feature map.

For a vehicle (e.g., the vehicle 502) to perceive its environment (e.g., to detect objects surrounding the vehicle), the vehicle may be configured to extract semantic representations from multiple sensors (e.g., cameras, Lidars, etc.) and fuse these representations into a single “bird's-eye-view” coordinate frame, which can be used to perform various tasks such as motion planning. Lift, splat, shoot (LSS) may refer to a technique that takes multi-view image data from any camera rig and outputs a semantics in the reference frame of the camera rig as determined by the extrinsic and intrinsic of the cameras. Lift may refer to a process that estimates the depth distribution of the feature points after down-sampling the image plane for each camera image, and obtains the cone of view (point cloud) containing image features. Splat may refer to a process that combines the internal and external parameters of the camera distribute the view cones (point clouds) of all cameras into the BEV grid, and performs sum-pooling calculations on multiple view cone points in each grid to form a BEV feature ma. Shoot may refer to a process that uses the task head to process the BEV feature map, output the perception result.

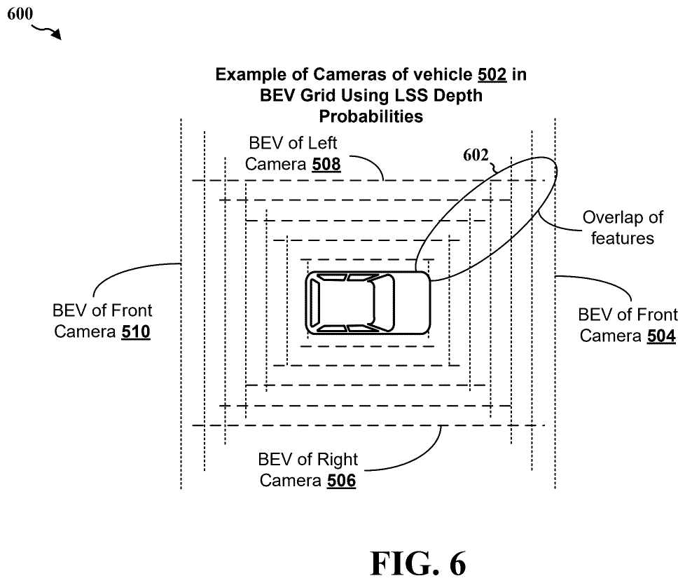

FIG. 6 is a diagram 600 illustrating an example of cameras in a BEV grid using LSS depth probabilities in accordance with various aspects of the present disclosure. As shown at 602, after images captured by different cameras of the vehicle 502 are transformed to BEV, there may be an overlap of features between cameras.

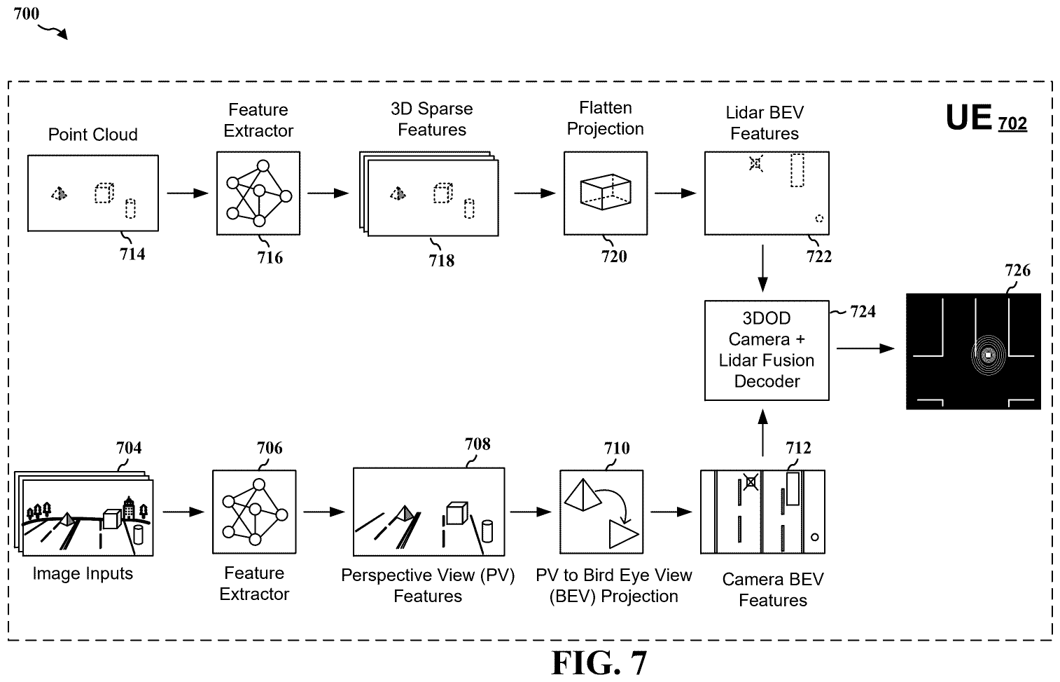

FIG. 7 is a diagram 700 illustrating an example framework of fusing outputs from different types of sensors in accordance with various aspects of the present disclosure. In some scenarios, as a vehicle may be equipped with different types of sensors, such as Lidar(s) and camera(s). A vehicle (which may also be referred to as a vehicle UE), an ADAS of the vehicle, an on-board unit (OBU) of the vehicle, or an image processing device associated with the vehicle, etc. (collectively as a “UE 702” for purposes of illustration) may be configured to receive outputs from at least one camera and at least one Lidar, and fuse the outputs from the at least one camera and the at least one Lidar.

At 704, the UE 702 may obtain a set of images from at least one camera (which may also be referred to as image inputs). For example, as discussed in connection with FIG. 5, the vehicle 502 may use its front camera 504 to capture the front views of the vehicle 502, and/or use its rear camera 510 to capture the rear views of the vehicle 502, etc. At 706, the UE 702 may be configured to extract a set of features from the set of images, such as by using a feature extractor module (which may be an NN/ML model). For example, as shown at 708, the set of features may be a set of perspective view (PV) features related to the driving and roads, such as vehicles, traffics objects (e.g., traffic lines, road signs, traffic lights, traffic equipments, etc.), pedestrians, animals, and/or anything that may typically be presented on roads, etc. At 710, the UE 702 may convert the set of features (e.g., the set of PV features) to a set of camera bird's eye view (BEV) features. For example, as shown at 712, the PV features (e.g., 3D features) extracted from the set of images shown at 708 may be projected to a 2D plane as a set of camera BEV features.

Similarly, at 714, the UE 702 may obtain a set of point clouds from at least one Lidar. At 716, the UE 702 may be configured to extract a set of features from the set of point clouds, such as by using a feature extractor module (which may be an NN/ML model). For example, as shown at 718, the set of features may be a set of 3D sparse features of objects detected by the at least one Lidar. At 720, the UE 702 may convert the set of features to a set of Lidar BEV features via a flatten projection. For example, as shown at 722, the 3D sparse features extracted from the set of point clouds may be projected to a 2D plane as a set of Lidar BEV features.

At 724, the UE 702 may fuse the set of camera BEV features (e.g., obtained at 712) and the set of Lidar BEV features (e.g., obtained at 722), such as by using a 3DOD fusion decoder, to obtain a set of fused BEV features as shown at 726. In some examples, the fusion of features obtained from different types of sensors may be referred to as the “multi-modal fusion.” Note while FIG. 7 uses camera and Lidar as an illustration, other types of sensors or combination of sensors may also be used, such as radar, ultrawide band (UWB) sensors, ultrasonic sensors, etc.

As discussed in connection with FIGS. 5 and 6, some features obtained from different cameras may overlap with each other. Similarly, some features obtained from different types of sensors may also overlap with each other. As typical/current approaches of fusing features from different sensors in the BEV projection may result in overlapping of features in many cells of a BEV grid, this may make it difficult for a UE to distinguish between features captured by different sensors in some scenarios.

Aspects presented herein may improve the overall performance of object detection performed by multiple sensors and/or different types of sensors. Aspects presented herein may enable a UE to effectively distinguish (or train a machine learning (ML) model to effectively distinguish) features captured by different sensors or different types of sensors by configuring the UE to embed/associate features from each sensor before concatenating them, which may be referred to as the “sensor embedding(s)” for purposes of the present disclosure. As such, the UE may be able to distinguish the source of the features and account for sensor variability with higher accuracy. The sensor embeddings described herein may help reduce feature overlapping by assigning a unique signature to features from each sensor in the BEV grid, making it easier to identify the source of the feature. The sensor embeddings, whether fixed or learned, may be configured to encode differences in sensor characteristics like field-of-view. This may enable a UE (or a model/algorithm used by the UE) to better integrate features despite variability. In some implementations, by configuring the sensor embeddings to be conditional on a learned sensor feature vector, it may allow the embedding dimensions to vary based on location-specific factors such as the visibility and/or proximity (which may address the dependency on location). Also, the learning sensor embeddings may be tailored to each sensor's modalities and the environment in a more optimized approach than typical/current summation, and may improve feature representation and downstream task performance.

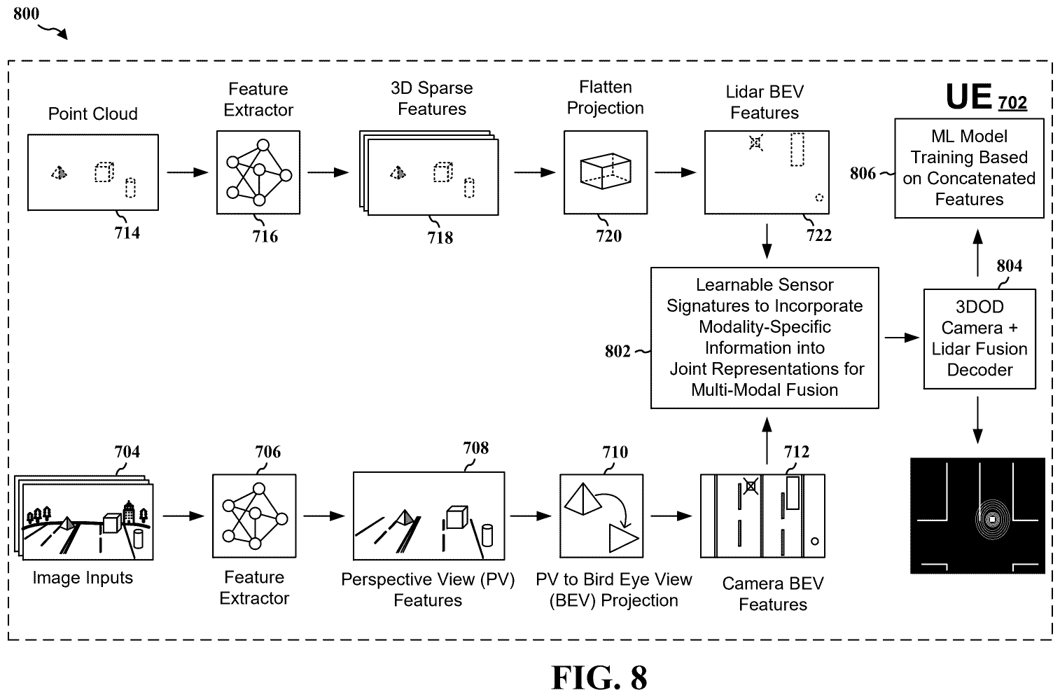

FIG. 8 is a diagram 800 illustrating an example framework of fusing outputs from different types of sensors with sensor embeddings in accordance with various aspects of the present disclosure. In one aspect of the present disclosure, to enable the UE 702 to effectively distinguish features captured by different sensors or different types of sensors, the UE 702 may be configured to embed/associate features from each sensor (which may also be referred to as “sensor embedding of features”).

For example, at 802, after each sensor (e.g., a Lidar, a radar, an ultrasonic sensor, a UWB sensor, a camera, etc.) of the UE 702 extracts a set of features (e.g., as described in connection with 706 and 716), the UE 702 (or an algorithm/model implemented at the UE 702) may be configured to add/map an “embedding vector” to the set of features. This embedding vector may be configured to be fixed (which may be referred to as the “fixed sensor embedding(s)”), which may be similar to a position embedding in a transformer using sine and cosine, or the embedding vector may be learned (which may be referred to as the “learnable sensor embedding(s)”). The embedding vector may act as a signature that enables the UE 702 (or the algorithm/model run by the UE 702) to understand/differentiate which sensor(s) a set of features comes from.

As an illustration, for fixed sensor embeddings, if the UE 702 uses N sensors to collect data (e.g., the perception data, data related to surrounding of the UE 702, etc.), the N sensors may be labeled from 1 through N. For each sensor i, the UE 702 may be configured to extract a feature vector xᵢ of length. A sensor embedding may be an additional vector eᵢ of length E that is added/mapped to the feature vector. For example, if the sensor embeddings are fixed (e.g., based on using sine/cosine):

$${e}_{i , j} = sin ( j / E ) for j from 1 to E / 2$$

$${e}_{i , j} = cos ( ( j - E / 2 ) / E ) for j from E / 2 + 1 to E$$

Such may configuration enable the UE 702 to add/map positional information to features extracted by each sensor of the UE 702, thereby allowing the UE 702 to distinguish features extracted by different sensors (e.g., based on their associated positional information).

On the other hand, if the sensor embeddings are configured to be learned (i.e., to be learnable sensor embeddings), then the additional vector eᵢ may be a learned weight matrix of size N×E instead. In this case, the final represented vector for sensor i's data may be represented by:

$${z}_{i} = {x}_{i} + {e}_{i}$$

where zᵢ is of length D+E and D may be the length/dimensionality of the original feature vector extracted for each sensor, before the sensor embedding vector eᵢ of length E is added. In other words, the total length of the represented vector zᵢ after adding the embedding is D+E. Then, when the UE 702 fuses the data from all sensors, the UE 702 may concatenate all the zᵢ vectors from each sensor:

$$z = [ {z}_{1} ; {z}_{2} ; … ; {z}_{N} ]$$

of the final length N*(D+E). In other words, each sensor i may extract a feature vector xᵢ of length xᵢ from its data. Then, an embedding vector et of length E is added to the feature vector, either as fixed sine/cosine embeddings or learned embeddings. The represented vector for sensor i's data is zᵢ=xᵢ+eᵢ, which has a length of D+E. When fusing data from all N sensors, the zᵢ vectors from each sensor are concatenated, resulting in a final vector z of length N*(D+E). Thus, the UE 702 (or the algorithm/model run by the UE 702) may then learn the relationship(s) between sensors from these embedded representations, such as during the training of an algorithm and/or a machine learning model.

In another aspect of the present disclosure, to make the sensor embeddings learnable for each sensor, the UE 702 may be configured to incorporate a sensor's intrinsic parameters to features extracted by the sensor, such as incorporating the focal length, the principal point, and/or the FOV of the sensor to the features extracted by the sensor. For example, let fᵢₓ, f_{iy} be the focal lengths, cᵢₓ, c_{iy} be the principal points for sensor i. The intrinsic parameter matrix Kᵢ for sensor i may be represented by:

$${K}_{i} = [ \begin{matrix}{f}_{ix} & 0 & {c}_{i x} \\ 0 & {f}_{i y} & {c}_{i y} \\ 0 & 0 & 0\end{matrix} ]$$

Instead of a fixed embedding et, a learnable embedding matrix Eᵢ of size P×Q may be defined for the UE 702. Then, the embedded feature vector zᵢ may be represented by:

$${z}_{i} = {K}_{i} * ( {x}_{i} - {μ}_{i} ) + {E}_{i}$$

where xᵢ is the extracted feature vector of size H×W×C, μᵢ is the mean of xᵢ, Kᵢ projects the features based on the sensor's intrinsic parameter(s), and Eᵢ customizes the embedding for sensor i. Such configuration may enable the embedded feature vector zᵢ to encode both the raw sensor features transformed by Kᵢ as well as the learnable embedding Eᵢ that captures the sensor-specific characteristic(s). In some examples, the UE 702 may also be configured to incorporate the FOV of the sensor(s) to the features by scaling/clipping xᵢ before applying Kᵢ based on each sensor's horizontal and vertical FOV angles.

In another aspect of the present disclosure, when the UE 702 is configured to detect road objects using different types of sensors (e.g., to combine outputs from different types of sensors based on the multi-modal fusion), the UE 702 may be configured to implement different embedding dimensions (e.g., to feature(s) extracted by different sensors) for different sensor types as they may provide different modalities of information. For example, as a camera and a Lidar may provide different modalities of information, if the UE 702 uses at least one camera and at least one Lidar (which may be referred to as a “camera-Lidar sensor” or a “camera-Lidar sensor modality” for purposes of the present disclosure), the UE 702 may be configured to use different embedding dimensions for the at least one camera and the at least one Lidar.

As an illustration, for N_{c} cameras that are indexed with i=1, . . . , N_{c} (e.g., for four cameras, i=1, 2, 3, and 4), an extracted feature dimension for these cameras may be indicated by D_{c}. For Nₗ Lidars that are indexed with i=N_{c}+1, . . . , N_{c}+Nₗ (e.g., for four Lidars, i=5, 6, 7, and 8), the extracted feature dimension for these Lidars may be indicated by Dₗ. The camera embedding dimension may be represented by E_{c} and the LiDAR embedding dimension may be represented by Eₗ. Then, the embedded feature vectors for the at least one camera may be represented based on:

$${z}_{i} = {x}_{i} + {E}_{i}$$

where xᵢ is the feature vector of dimension D_{c}, Eᵢ is the learnable embedding matrix of dimension D_{c}×E_{c}, and zᵢ is the embedded feature vector of dimension D_{c}+E_{c}. Similarly, the embedded feature vectors for the at least one Lidar may be represented based on:

$${z}_{i} = {x}_{i} + {F}_{i}$$

where xᵢ is the feature vector of dimension Dₗ, Fᵢ is the learnable embedding matrix of dimension Dₗ×Eₗ, and zᵢ is the embedded feature vector of dimension Dₗ+Eₗ. As such, this may enable the UE 702 to use different capacity embeddings that are tailored to each sensor type's unique data modalities.

In another aspect of the present disclosure, the embedding dimensions for different sensors may be configured to be conditional on learned sensor-specific feature(s), which may provide adaptation based on scene/environment, such as providing dynamic embeddings for camera-Lidar sensor modality. For example, for each sensor i, the sensor may extract a feature vector fᵢ that captures a set of scene properties. For N_{c} cameras that are indexed with i=1, . . . , N_{c} (e.g., for four cameras, i=1, 2, 3, and 4), the feature vector fᵢ has dimension S. Similarly, for Nₗ Lidars that are indexed with i=N_{c}+1, . . . , N_{c}+Nₗ (e.g., for four Lidars, i=5, 6, 7, and 8), the feature vector fᵢ has dimension S.

Then, the UE 702 may pass the fᵢ through a set of multi-layer perceptron (MLPs) to obtain a set of embedding dimensions. For example, for cameras: E_{c,i}=MLPC(fᵢ) where E_{c,i} is the embedding dimension for camera i, and for Lidar: E_{l,i}=MLPL(fᵢ) where E_{l,i} is the embedding dimension for Lidar. The embedded feature vectors for cameras may be based on:

$${z}_{c , i} = {x}_{c , i} + {E}_{c , i} * {e}_{c , i}$$

where x_{c,i} is feature vector of dimension D_{c}, E_{c,i} is learnable matrix of dimension D_{c}×E_{c,i}, and e_{c,i} is embedding vector of length E_{c,I}. Similarly, the embedded feature vectors for lidars may be based on:

$${z}_{l , i} = {x}_{l , i} + {E}_{l , i} * {e}_{l , i}$$

where x_{l,i} is feature vector of dimension Dₗ, E_{l,i} is learnable matrix of dimension Dl×E_{l,i}, and e_{l,i} is embedding vector of length E_{l,i}. As such, this may allow embedding dimensions to be dynamically adapted based on the feature vector fᵢ for each sensor sample.

In another aspect of the present disclosure, the UE 702 may also be configured to apply or to use an attention mechanism to focus on camera-Lidar embeddings. For purposes of the present disclosure, an attention mechanism may be used in the field of machine learning (ML), such as in neural networks (NNs), to improve the performance of ML models on tasks involving sequential data. For example, an attention mechanism may enable an ML model to focus on different parts of the input sequence when making predictions, rather than treating the entire input sequence uniformly. This may mimic a human's ability to selectively pay attention to different parts of information when processing complex data.

As an illustration, referring back to FIG. 8, at 804, after obtaining the embedded features z_{c,i} and z_{l,i} for each sensor i (e.g., cameras 1-4 and Lidars 5-8) as discussion above, the UE 702 may be configured to concatenate the embedded features based on:

$$z = [ zc , 1 , zc , 2 , … , zc , Nc , zl , Nc + 1 , … , zl , Nc + N l ]$$

where the UE 702 may apply a multi-head attention mechanism with key=zc (e.g., the camera embedded features), query=zl (e.g., the Lidar embedded features), and value=z (e.g., the concatenated features). Then, the attention outputs a may be represented by a=Attention(zc, zl, z), and the UE 702 may fuse the attended outputs from each modality based on h=MLP([a, z]). This may enable the Lidar embeddings to attend over the camera features and vice versa, allowing the UE 702 to focus on the most relevant cross-modal information between sensors (e.g., between the camera and the Lidar). The attended outputs are then fused with an MLP to integrate information across modalities. This attention mechanism may help the UE 702 to capture correlations between camera and Lidar views that may not be evident from just concatenating the embedded features.

In some implementations, as shown at 806, the UE 702 may be configured to train a machine learning (ML) model to identify relationships between different sensors based on the concatenated sets of features and the corresponding embedded vectors. In some examples, if the ML model training is performed at a remote entity (e.g., at a server), the UE 702 may also be configured to output the concatenated sets of features and the corresponding embedded vectors to the remote entity for training of the ML model (e.g., for identification of the relationships between the different sensors in the multiple sensors). In addition, if the UE 702 is training the ML model, the UE 702 may also output an indication of the trained ML model, such as transmitting the indication of the trained ML model, or store the indication of the trained ML model.

Summing up features from different cameras in the BEV projection may result in overlapping features in many cells of the BEV grid, thus making it difficult to distinguish between features captured by different cameras. The current summation approach fails to optimize the pooling operation for specific sensor characteristics or the location within the BEV, and that may impact downstream tasks utilizing the BEV feature map. Aspects presented herein may enable a UE (e.g., a vehicle that is configured to perform road object detection using multiple sensors) to embed features from each sensor before summing them so as to distinguish the source of the features and account for sensor variability. A unique signature is applied to features from each sensor in the BEV grid to identify the source. In another aspect, the sensor's intrinsic parameters (focal length, principal point, FOV, etc.) are used to identify and distinguish the sensors. In another aspect, different embedding dimensions are used for different sensor types (camera, lidar). In a further aspect, embedding dimensions are conditional on learned scene features per sensor, thus allowing for dynamic adaptation based on environment.

For example, in one aspect of the present disclosure, fixed sensor embeddings using sine/cosine functions may be used to add positional signatures to sensor features. This may help a UE to distinguish features between sensors. In another example, learnable sensor embeddings that incorporate intrinsic parameters like focal length and principal point may be used to transform features based on sensor characteristics, which may allow customizing embedding per sensor. In addition, different embedding dimensions may be used for different sensor types like camera and Lidar since they provide different modalities which allows tailoring capacity. The embedding dimensions may also be made conditional on learned scene features per sensor, allowing dynamic adaptation based on environment. In some examples, a cross-attention mechanism may be applied between camera and Lidar embedded features to focus on relevant cross-modal correlations, where attended features may be fused across modalities using MLP to integrate information.

Aspects presented herein allow a model (e.g., an ML model) to learn relationships between sensors and adapt the embedding based on sensor characteristics and environment. The cross-modal attention helps capture correlations across different data modalities. For examples, aspects presented herein allow a deep learning model to understand which sensors the input features are coming from. This gives the model an additional context beyond just the raw features. The embeddings may encode sensor-specific characteristics like focal length, principal point, field of view, etc. This helps the model leverage differences in how each sensor perceives the environment. The learnable embeddings allow the model to customize the embedding for each sensor during training based on the data, rather than using fixed embeddings. Using different embedding dimensions for different sensor types lets the model tailor the embedding capacity to each sensor's unique data modality. Conditioning the embedding dimensions on learned sensor features also makes the embeddings adaptive to the scene/environment, rather than using fixed dimensions. The multi-head attention between camera and Lidar embeddings helps capture correlations between views that may not be evident from just concatenating embedded features. This cross-modal attention can integrate information more effectively. Fusing the attended outputs with the original embedded features using an MLP helps combine information from attention with the original embedded context for each sensor. In summary, the proposed sensor embeddings approach provide additional context about the sensor source to the model, may be customized for each sensor, and the attention mechanism fosters cross-modal learning, all of which may provide more accurate and robust predictions.

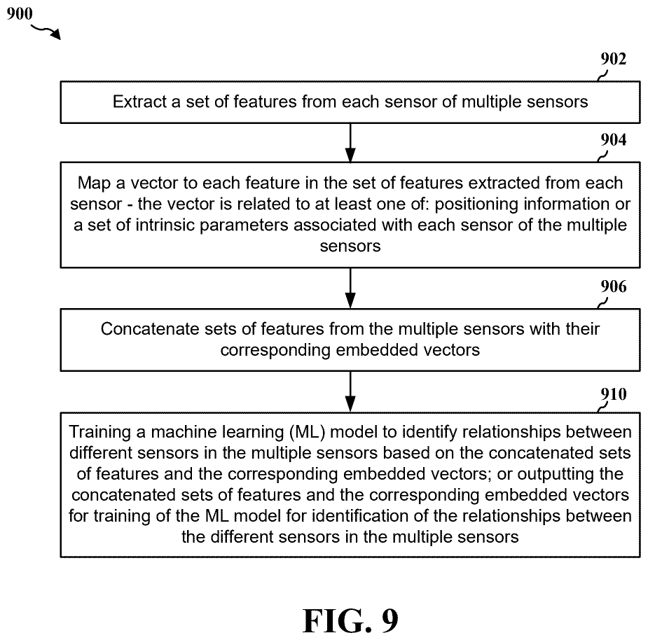

FIG. 9 is a flowchart 900 of wireless communication (or object tracking) at a user equipment (UE). The method may be performed by a UE (e.g., the UE 104, 702; the vehicle 502; the apparatus 1104). The method may enable a UE to effectively distinguish (or train a machine learning (ML) model to effectively distinguish) features captured by different sensors or different types of sensors by configuring the UE to embed/associate features from each sensor before concatenating them.

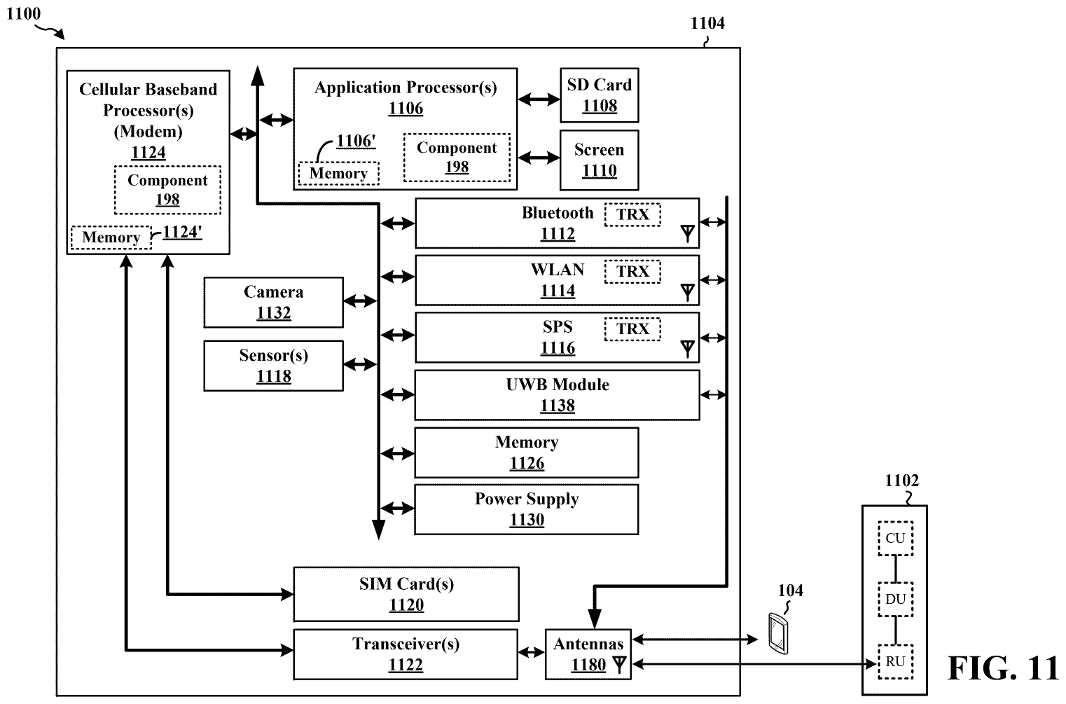

At 902, the UE may extract a set of features from each sensor of multiple sensors, such as described in connection with FIGS. 7 and 8. For example, as discussed in connection with 706 of FIG. 7, the UE 702 may be configured to extract a set of features from the set of images, such as by using a feature extractor module (which may be an NN/ML model), and as discussed in connection with 716 of FIG. 7, the UE 702 may be configured to extract a set of features from the set of point clouds. The extraction of the set of features may be performed by, e.g., the multi-modal fusion component 198, the one or more sensors 1118, the camera 1132, the UWB module 1138, the transceiver(s) 1122, the cellular baseband processor(s) 1124, and/or the application processor(s) 1106 of the apparatus 1104 in FIG. 11.

At 904, the UE may map a vector to each feature in the set of features extracted from each sensor, the vector is related to at least one of: positioning information or a set of intrinsic parameters associated with each sensor of the multiple sensors, such as described in connection with FIG. 8. For example, at 802, after each sensor (e.g., a Lidar, a radar, an ultrasonic sensor, a UWB sensor, a camera, etc.) of the UE 702 extracts a set of features (e.g., as described in connection with 706 and 716), the UE 702 (or an algorithm/model implemented at the UE 702) may be configured to add/map an “embedding vector” to the set of features. This embedding vector may be configured to be fixed (which may be referred to as the “fixed sensor embedding(s)”), which may be similar to a position embedding in a transformer using sine and cosine, or the embedding vector may be learned (which may be referred to as the “learnable sensor embedding(s)”). The embedding vector may act as a signature that enables the UE 702 (or the algorithm/model run by the UE 702) to understand/differentiate which sensor(s) a set of features comes from. The mapping of the vector may be performed by, e.g., the multi-modal fusion component 198, the one or more sensors 1118, the camera 1132, the UWB module 1138, the transceiver(s) 1122, the cellular baseband processor(s) 1124, and/or the application processor(s) 1106 of the apparatus 1104 in FIG. 11.

In one example, to map the vector to each feature in the set of features extracted from each sensor, the UE may be configured to embed the vector into each feature in the set of features extracted from each sensor. In some implementations, the multiple sensors may include different types of sensors, and where vectors mapped to features extracted from the different types of sensors may be associated with different embedding dimensions. In some implementations, the different types of sensors may include at least one of camera sensors, light detection and ranging (Lidar) sensors, or camera-Lidar sensors. In some implementations, the UE may select an embedding dimension for each type of sensor in the different types of sensors based on corresponding extracted features. In some implementations, the corresponding extracted features may include scene properties or environmental properties.

At 906, the UE may concatenate sets of features from the multiple sensors with their corresponding embedded vectors, such as described in connection with FIGS. 7 and 8. For example, as discussed in connection with 804 of FIG. 8, after obtaining the embedded features z_{c,i} and z_{l,i} for each sensor i (e.g., cameras 1-4 and Lidars 5-8) as discussion above, the UE 702 may be configured to concatenate the embedded features based on: z=[zc, 1, zc, 2, . . . , zc, Nc, zl, Nc+1, . . . , zl, Nc+Nl], where the UE 702 may apply a multi-head attention mechanism with key=zc (e.g., the camera embedded features), query=zl (e.g., the Lidar embedded features), and value=z (e.g., the concatenated features). The concatenation of the set of features may be performed by, e.g., the multi-modal fusion component 198, the one or more sensors 1118, the camera 1132, the UWB module 1138, the transceiver(s) 1122, the cellular baseband processor(s) 1124, and/or the application processor(s) 1106 of the apparatus 1104 in FIG. 11.

At 910, the UE may train an ML model to identify relationships between different sensors in the multiple sensors based on the concatenated sets of features and the corresponding embedded vectors, or output the concatenated sets of features and the corresponding embedded vectors for training of the ML model for identification of the relationships between the different sensors in the multiple sensors, such as described in connection with FIG. 8. For example, at 806, the UE 702 may be configured to train an ML model to identify relationships between different sensors based on the concatenated sets of features and the corresponding embedded vectors. In some examples, if the ML model training is performed at a remote entity (e.g., at a server), the UE 702 may also be configured to output the concatenated sets of features and the corresponding embedded vectors to the remote entity for training of the ML model (e.g., for identification of the relationships between the different sensors in the multiple sensors). The training of the ML model and/or the outputting of the concatenated sets of features may be performed by, e.g., the multi-modal fusion component 198, the one or more sensors 1118, the camera 1132, the UWB module 1138, the transceiver(s) 1122, the cellular baseband processor(s) 1124, and/or the application processor(s) 1106 of the apparatus 1104 in FIG. 11.

In one example, the UE may apply an attention mechanism to the concatenated sets of features to obtain a set of attended features associated with the multiple sensors, and fuse the set of attended features, such as described in connection with FIG. 8. For example, the UE 702 may also be configured to apply or to use an attention mechanism to focus on camera-Lidar embeddings. The application of the attention mechanism may be performed by, e.g., the multi-modal fusion component 198, the one or more sensors 1118, the camera 1132, the UWB module 1138, the transceiver(s) 1122, the cellular baseband processor(s) 1124, and/or the application processor(s) 1106 of the apparatus 1104 in FIG. 11.

In some implementations, to train the ML model to identify the relationships between the different sensors in the multiple sensors based on the concatenated sets of features and the corresponding embedded vectors, the UE may be configured to train the ML model to identify the relationships between the different sensors in the multiple sensors based on the fused set of attended features. In some implementations, to apply the attention mechanism to the concatenated sets of features to obtain the set of attended features associated with the multiple sensors, the UE may be configured to attend to a first subset of concatenated features in the sets of concatenated features that is associated with a first sensor in the multiple sensors over a second subset of concatenated features in the sets of concatenated features that is associated with a second sensor in the multiple sensors based on relevant cross-modal information between the first sensor and the second sensor. In some implementations, to fuse the set of attended features, the UE may be configured to fuse the set of attended features with a multilayer perceptron (MLP) to integrate information across the multiple sensors. In some implementations, to output the concatenated sets of features and the corresponding embedded vectors for the training of the ML model, the UE may be configured to output the fused set of attended features for the training of the ML model.

In another example, the UE may output an indication of the trained ML model, such as described in connection with FIG. 8. For example, if the UE 702 is training the ML model, the UE 702 may also output an indication of the trained ML model, such as transmitting the indication of the trained ML model, or store the indication of the trained ML model. The output of the indication may be performed by, e.g., the multi-modal fusion component 198, the one or more sensors 1118, the camera 1132, the UWB module 1138, the transceiver(s) 1122, the cellular baseband processor(s) 1124, and/or the application processor(s) 1106 of the apparatus 1104 in FIG. 11. In some implementations, to output the indication of the trained ML model, the UE may be configured to transmit the indication of the trained ML model, or store the indication of the trained ML model.

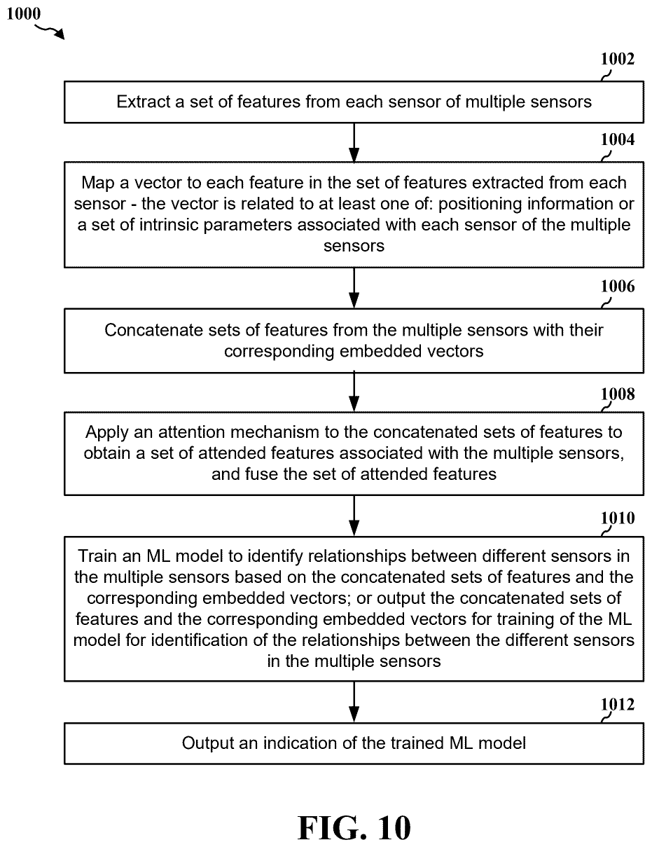

FIG. 10 is a flowchart 1000 of wireless communication (or object tracking) at a user equipment (UE). The method may be performed by a UE (e.g., the UE 104, 702; the vehicle 502; the apparatus 1104). The method may enable a UE to effectively distinguish (or train a machine learning (ML) model to effectively distinguish) features captured by different sensors or different types of sensors by configuring the UE to embed/associate features from each sensor before concatenating them.

At 1002, the UE may extract a set of features from each sensor of multiple sensors, such as described in connection with FIGS. 7 and 8. For example, as discussed in connection with 706 of FIG. 7, the UE 702 may be configured to extract a set of features from the set of images, such as by using a feature extractor module (which may be an NN/ML model), and as discussed in connection with 716 of FIG. 7, the UE 702 may be configured to extract a set of features from the set of point clouds. The extraction of the set of features may be performed by, e.g., the multi-modal fusion component 198, the one or more sensors 1118, the camera 1132, the UWB module 1138, the transceiver(s) 1122, the cellular baseband processor(s) 1124, and/or the application processor(s) 1106 of the apparatus 1104 in FIG. 11.

At 1004, the UE may map a vector to each feature in the set of features extracted from each sensor, the vector is related to at least one of: positioning information or a set of intrinsic parameters associated with each sensor of the multiple sensors, such as described in connection with FIG. 8. For example, at 802, after each sensor (e.g., a Lidar, a radar, an ultrasonic sensor, a UWB sensor, a camera, etc.) of the UE 702 extracts a set of features (e.g., as described in connection with 706 and 716), the UE 702 (or an algorithm/model implemented at the UE 702) may be configured to add/map an “embedding vector” to the set of features. This embedding vector may be configured to be fixed (which may be referred to as the “fixed sensor embedding(s)”), which may be similar to a position embedding in a transformer using sine and cosine, or the embedding vector may be learned (which may be referred to as the “learnable sensor embedding(s)”). The embedding vector may act as a signature that enables the UE 702 (or the algorithm/model run by the UE 702) to understand/differentiate which sensor(s) a set of features comes from. The mapping of the vector may be performed by, e.g., the multi-modal fusion component 198, the one or more sensors 1118, the camera 1132, the UWB module 1138, the transceiver(s) 1122, the cellular baseband processor(s) 1124, and/or the application processor(s) 1106 of the apparatus 1104 in FIG. 11.

In one example, to map the vector to each feature in the set of features extracted from each sensor, the UE may be configured to embed the vector into each feature in the set of features extracted from each sensor. In some implementations, the multiple sensors may include different types of sensors, and where vectors mapped to features extracted from the different types of sensors may be associated with different embedding dimensions. In some implementations, the different types of sensors may include at least one of camera sensors, light detection and ranging (Lidar) sensors, or camera-Lidar sensors. In some implementations, the UE may select an embedding dimension for each type of sensor in the different types of sensors based on corresponding extracted features. In some implementations, the corresponding extracted features may include scene properties or environmental properties.

At 1006, the UE may concatenate sets of features from the multiple sensors with their corresponding embedded vectors, such as described in connection with FIGS. 7 and 8. For example, as discussed in connection with 804 of FIG. 8, after obtaining the embedded features z_{c,i} and z_{l,i} for each sensor i (e.g., cameras 1-4 and Lidars 5-8) as discussion above, the UE 702 may be configured to concatenate the embedded features based on: z=[zc, 1, zc, 2, . . . , zc, Nc, zl, Nc+1, . . . , zl, Nc+Nl], where the UE 702 may apply a multi-head attention mechanism with key=zc (e.g., the camera embedded features), query=zl (e.g., the Lidar embedded features), and value=z (e.g., the concatenated features). The concatenation of the set of features may be performed by, e.g., the multi-modal fusion component 198, the one or more sensors 1118, the camera 1132, the UWB module 1138, the transceiver(s) 1122, the cellular baseband processor(s) 1124, and/or the application processor(s) 1106 of the apparatus 1104 in FIG. 11.

At 1010, the UE may train an ML model to identify relationships between different sensors in the multiple sensors based on the concatenated sets of features and the corresponding embedded vectors, or output the concatenated sets of features and the corresponding embedded vectors for training of the ML model for identification of the relationships between the different sensors in the multiple sensors, such as described in connection with FIG. 8. For example, at 806, the UE 702 may be configured to train an ML model to identify relationships between different sensors based on the concatenated sets of features and the corresponding embedded vectors. In some examples, if the ML model training is performed at a remote entity (e.g., at a server), the UE 702 may also be configured to output the concatenated sets of features and the corresponding embedded vectors to the remote entity for training of the ML model (e.g., for identification of the relationships between the different sensors in the multiple sensors). The training of the ML model and/or the outputting of the concatenated sets of features may be performed by, e.g., the multi-modal fusion component 198, the one or more sensors 1118, the camera 1132, the UWB module 1138, the transceiver(s) 1122, the cellular baseband processor(s) 1124, and/or the application processor(s) 1106 of the apparatus 1104 in FIG. 11.

In one example, as shown at 1008, the UE may apply an attention mechanism to the concatenated sets of features to obtain a set of attended features associated with the multiple sensors, and fuse the set of attended features, such as described in connection with FIG. 8. For example, the UE 702 may also be configured to apply or to use an attention mechanism to focus on camera-Lidar embeddings. The application of the attention mechanism may be performed by, e.g., the multi-modal fusion component 198, the one or more sensors 1118, the camera 1132, the UWB module 1138, the transceiver(s) 1122, the cellular baseband processor(s) 1124, and/or the application processor(s) 1106 of the apparatus 1104 in FIG. 11.

In some implementations, to train the ML model to identify the relationships between the different sensors in the multiple sensors based on the concatenated sets of features and the corresponding embedded vectors, the UE may be configured to train the ML model to identify the relationships between the different sensors in the multiple sensors based on the fused set of attended features. In some implementations, to apply the attention mechanism to the concatenated sets of features to obtain the set of attended features associated with the multiple sensors, the UE may be configured to attend to a first subset of concatenated features in the sets of concatenated features that is associated with a first sensor in the multiple sensors over a second subset of concatenated features in the sets of concatenated features that is associated with a second sensor in the multiple sensors based on relevant cross-modal information between the first sensor and the second sensor. In some implementations, to fuse the set of attended features, the UE may be configured to fuse the set of attended features with a multilayer perceptron (MLP) to integrate information across the multiple sensors. In some implementations, to output the concatenated sets of features and the corresponding embedded vectors for the training of the ML model, the UE may be configured to output the fused set of attended features for the training of the ML model.

In another example, as shown at 1012, the UE may output an indication of the trained ML model, such as described in connection with FIG. 8. For example, if the UE 702 is training the ML model, the UE 702 may also output an indication of the trained ML model, such as transmitting the indication of the trained ML model, or store the indication of the trained ML model. The output of the indication may be performed by, e.g., the multi-modal fusion component 198, the one or more sensors 1118, the camera 1132, the UWB module 1138, the transceiver(s) 1122, the cellular baseband processor(s) 1124, and/or the application processor(s) 1106 of the apparatus 1104 in FIG. 11. In some implementations, to output the indication of the trained ML model, the UE may be configured to transmit the indication of the trained ML model, or store the indication of the trained ML model.

FIG. 11 is a diagram 1100 illustrating an example of a hardware implementation for an apparatus 1104. The apparatus 1104 may be a UE, a component of a UE, or may implement UE functionality. In some aspects, the apparatus 1104 may include at least one cellular baseband processor 1124 (also referred to as a modem) coupled to one or more transceivers 1122 (e.g., cellular RF transceiver). The cellular baseband processor(s) 1124 may include at least one on-chip memory 1124′. In some aspects, the apparatus 1104 may further include one or more subscriber identity modules (SIM) cards 1120 and at least one application processor 1106 coupled to a secure digital (SD) card 1108 and a screen 1110. The application processor(s) 1106 may include on-chip memory 1106′. In some aspects, the apparatus 1104 may further include a Bluetooth module 1112, a WLAN module 1114, an ultrawide band (UWB) module 1138, an SPS module 1116 (e.g., GNSS module), one or more sensors 1118 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1126, a power supply 1130, and/or a camera 1132. The Bluetooth module 1112, the UWB module 1138, the WLAN module 1114, and the SPS module 1116 may include an on-chip transceiver (TRX) (or in some cases, just a receiver (RX)). The Bluetooth module 1112, the WLAN module 1114, and the SPS module 1116 may include their own dedicated antennas and/or utilize the antennas 1180 for communication. The cellular baseband processor(s) 1124 communicates through the transceiver(s) 1122 via one or more antennas 1180 with the UE 104 and/or with an RU associated with a network entity 1102. The cellular baseband processor(s) 1124 and the application processor(s) 1106 may each include a computer-readable medium/memory 1124′, 1106′, respectively. The additional memory modules 1126 may also be considered a computer-readable medium/memory. Each computer-readable medium/memory 1124′, 1106′, 1126 may be non-transitory. The cellular baseband processor(s) 1124 and the application processor(s) 1106 are each responsible for general processing, including the execution of software stored on the computer-readable medium/memory. The software, when executed by the cellular baseband processor(s) 1124/application processor(s) 1106, causes the cellular baseband processor(s) 1124/application processor(s) 1106 to perform the various functions described supra. The cellular baseband processor(s) 1124 and the application processor(s) 1106 are configured to perform the various functions described supra based at least in part of the information stored in the memory. That is, the cellular baseband processor(s) 1124 and the application processor(s) 1106 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor(s) 1124/application processor(s) 1106 when executing software. The cellular baseband processor(s) 1124/application processor(s) 1106 may be a component of the UE 350 and may include the at least one memory 360 and/or at least one of the TX processor 368, the RX processor 356, and the controller/processor 359. In one configuration, the apparatus 1104 may be at least one processor chip (modem and/or application) and include just the cellular baseband processor(s) 1124 and/or the application processor(s) 1106, and in another configuration, the apparatus 1104 may be the entire UE (e.g., see UE 350 of FIG. 3) and include the additional modules of the apparatus 1104.

As discussed supra, the multi-modal fusion component 198 may be configured to extract a set of features from each sensor of multiple sensors. The multi-modal fusion component 198 may also be configured to map a vector to each feature in the set of features extracted from each sensor, where the vector is related to at least one of: positioning information or a set of intrinsic parameters associated with each sensor of the multiple sensors. The multi-modal fusion component 198 may also be configured to concatenate sets of features from the multiple sensors with their corresponding embedded vectors. The multi-modal fusion component 198 may also be configured to train an ML model to identify relationships between different sensors in the multiple sensors based on the concatenated sets of features and the corresponding embedded vectors; or output the concatenated sets of features and the corresponding embedded vectors for training of the ML model for identification of the relationships between the different sensors in the multiple sensors. The multi-modal fusion component 198 may be within the cellular baseband processor(s) 1124, the application processor(s) 1106, or both the cellular baseband processor(s) 1124 and the application processor(s) 1106. The multi-modal fusion component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1104 may include a variety of components configured for various functions. In one configuration, the apparatus 1104, and in particular the cellular baseband processor(s) 1124 and/or the application processor(s) 1106, may include means for extracting a set of features from each sensor of multiple sensors. The apparatus 1104 may further include means for mapping a vector to each feature in the set of features extracted from each sensor, where the vector is related to at least one of: positioning information or a set of intrinsic parameters associated with each sensor of the multiple sensors. The apparatus 1104 may further include means for concatenating sets of features from the multiple sensors with their corresponding embedded vectors. The apparatus 1104 may further include means for training an ML model to identify relationships between different sensors in the multiple sensors based on the concatenated sets of features and the corresponding embedded vectors; or means for outputting the concatenated sets of features and the corresponding embedded vectors for training of the ML model for identification of the relationships between the different sensors in the multiple sensors.

In one configuration, the means for mapping the vector to each feature in the set of features extracted from each sensor may include configuring the apparatus 1104 to embed the vector into each feature in the set of features extracted from each sensor. In some implementations, the multiple sensors may include different types of sensors, and where vectors mapped to features extracted from the different types of sensors may be associated with different embedding dimensions. In some implementations, the different types of sensors may include at least one of camera sensors, Lidar sensors, or camera-Lidar sensors. In some implementations, the apparatus 1104 may further include means for selecting an embedding dimension for each type of sensor in the different types of sensors based on corresponding extracted features. In some implementations, the corresponding extracted features may include scene properties or environmental properties.

In another configuration, the apparatus 1104 may further include means for applying an attention mechanism to the concatenated sets of features to obtain a set of attended features associated with the multiple sensors, and means for fusing the set of attended features.

In some implementations, the means for training the ML model to identify the relationships between the different sensors in the multiple sensors based on the concatenated sets of features and the corresponding embedded vectors may include configuring the apparatus 1104 to train the ML model to identify the relationships between the different sensors in the multiple sensors based on the fused set of attended features. In some implementations, the means for applying the attention mechanism to the concatenated sets of features to obtain the set of attended features associated with the multiple sensors may include configuring the apparatus 1104 to attend to a first subset of concatenated features in the sets of concatenated features that is associated with a first sensor in the multiple sensors over a second subset of concatenated features in the sets of concatenated features that is associated with a second sensor in the multiple sensors based on relevant cross-modal information between the first sensor and the second sensor. In some implementations, the means for fusing the set of attended features may include configuring the apparatus 1104 to fuse the set of attended features with an MLP to integrate information across the multiple sensors. In some implementations, the means for outputting the concatenated sets of features and the corresponding embedded vectors for the training of the ML model may include configuring the apparatus 1104 to output the fused set of attended features for the training of the ML model.

In another configuration, the apparatus 1104 may further include means for outputting an indication of the trained ML model. In some implementations, the means for outputting the indication of the trained ML model may include configuring the apparatus 1104 to transmit the indication of the trained ML model, or store the indication of the trained ML model.

The means may be the multi-modal fusion component 198 of the apparatus 1104 configured to perform the functions recited by the means. As described supra, the apparatus 1104 may include the TX processor 368, the RX processor 356, and the controller/processor 359. As such, in one configuration, the means may be the TX processor 368, the RX processor 356, and/or the controller/processor 359 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of data processing, comprising: extracting a set of features from each sensor of multiple sensors; mapping a vector to each feature in the set of features extracted from each sensor, wherein the vector is related to at least one of: positioning information or a set of intrinsic parameters associated with each sensor of the multiple sensors; concatenating sets of features from the multiple sensors with their corresponding embedded vectors; and training a machine learning (ML) model to identify relationships between different sensors in the multiple sensors based on the concatenated sets of features and the corresponding embedded vectors; or outputting the concatenated sets of features and the corresponding embedded vectors for training of the ML model for identification of the relationships between the different sensors in the multiple sensors.

Aspect 2 is the method of aspect 1, wherein mapping the vector to each feature in the set of features extracted from each sensor comprises: embedding the vector into each feature in the set of features extracted from each sensor.

Aspect 3 is the method of aspect 1 or aspect 2, wherein the multiple sensors include different types of sensors, and wherein vectors mapped to features extracted from the different types of sensors are associated with different embedding dimensions.

Aspect 4 is the method of any of aspects 1 to 3, wherein the different types of sensors include at least one of camera sensors, light detection and ranging (Lidar) sensors, or camera-Lidar sensors.

Aspect 5 is the method of any of aspects 1 to 4, further comprising: selecting an embedding dimension for each type of sensor in the different types of sensors based on corresponding extracted features.

Aspect 6 is the method of any of aspects 1 to 5, wherein the corresponding extracted features include scene properties or environmental properties.

Aspect 7 is the method of any of aspects 1 to 6, further comprising: applying an attention mechanism to the concatenated sets of features to obtain a set of attended features associated with the multiple sensors; and fusing the set of attended features.

Aspect 8 is the method of any of aspects 1 to 7, wherein training the ML model to identify the relationships between the different sensors in the multiple sensors based on the concatenated sets of features and the corresponding embedded vectors comprises: training the ML model to identify the relationships between the different sensors in the multiple sensors based on the fused set of attended features.

Aspect 9 is the method of any of aspects 1 to 8, wherein applying the attention mechanism to the concatenated sets of features to obtain the set of attended features associated with the multiple sensors comprises: attending to a first subset of concatenated features in the sets of concatenated features that is associated with a first sensor in the multiple sensors over a second subset of concatenated features in the sets of concatenated features that is associated with a second sensor in the multiple sensors based on relevant cross-modal information between the first sensor and the second sensor.

Aspect 10 is the method of any of aspects 1 to 9, wherein fusing the set of attended features comprises: fusing the set of attended features with a multilayer perceptron (MLP) to integrate information across the multiple sensors.

Aspect 11 is the method of any of aspects 1 to 10, wherein outputting the concatenated sets of features and the corresponding embedded vectors for the training of the ML model comprises: outputting the fused set of attended features for the training of the ML model.

Aspect 12 is the method of any of aspects 1 to 11, further comprising: outputting an indication of the trained ML model.

Aspect 13 is the method of any of aspects 1 to 12, wherein outputting the indication of the trained ML model comprises: transmitting the indication of the trained ML model; or storing the indication of the trained ML model.

Aspect 14 is an apparatus for data processing, including: at least one memory; and at least one processor coupled to the at least one memory and, based at least in part on information stored in the at least one memory, the at least one processor, individually or in any combination, is configured to implement any of aspects 1 to 13.

Aspect 15 is the apparatus of aspect 14, further including one or more sensors coupled to the at least one processor.

Aspect 16 is an apparatus for data processing including means for implementing any of aspects 1 to 13.

Aspect 17 is a computer-readable medium (e.g., a non-transitory computer-readable medium) storing computer executable code, where the code when executed by a processor causes the processor to implement any of aspects 1 to 13.

What is claimed is:

1. An apparatus for wireless communication at a user equipment (UE), comprising:
at least one memory; and
at least one processor coupled to the at least one memory, the at least one processor, individually or in any combination, is configured to:
extract a set of features from each sensor of multiple sensors;
map a vector to each feature in the set of features extracted from each sensor, wherein the vector is related to at least one of: positioning information or a set of intrinsic parameters associated with each sensor of the multiple sensors;
concatenate sets of features from the multiple sensors with their corresponding embedded vectors; and
train a machine learning (ML) model to identify relationships between different sensors in the multiple sensors based on the concatenated sets of features and the corresponding embedded vectors; or output the concatenated sets of features and the corresponding embedded vectors for training of the ML model for identification of the relationships between the different sensors in the multiple sensors.

2. The apparatus of claim 1, wherein to map the vector to each feature in the set of features extracted from each sensor, the at least one processor, individually or in any combination, is configured to:
embed the vector into each feature in the set of features extracted from each sensor.

3. The apparatus of claim 2, wherein the multiple sensors include different types of sensors, and wherein vectors mapped to features extracted from the different types of sensors are associated with different embedding dimensions.

4. The apparatus of claim 3, wherein the different types of sensors include at least one of camera sensors, light detection and ranging (Lidar) sensors, or camera-Lidar sensors.

5. The apparatus of claim 4, wherein the at least one processor, individually or in any combination, is further configured to:
select an embedding dimension for each type of sensor in the different types of sensors based on corresponding extracted features.

6. The apparatus of claim 5, wherein the corresponding extracted features include scene properties or environmental properties.

7. The apparatus of claim 1, wherein the at least one processor, individually or in any combination, is further configured to:
apply an attention mechanism to the concatenated sets of features to obtain a set of attended features associated with the multiple sensors; and
fuse the set of attended features.

8. The apparatus of claim 7, wherein to train the ML model to identify the relationships between the different sensors in the multiple sensors based on the concatenated sets of features and the corresponding embedded vectors, the at least one processor, individually or in any combination, is configured to:
train the ML model to identify the relationships between the different sensors in the multiple sensors based on the fused set of attended features.

9. The apparatus of claim 7, wherein to apply the attention mechanism to the concatenated sets of features to obtain the set of attended features associated with the multiple sensors, the at least one processor, individually or in any combination, is configured to:
attend to a first subset of concatenated features in the sets of concatenated features that is associated with a first sensor in the multiple sensors over a second subset of concatenated features in the sets of concatenated features that is associated with a second sensor in the multiple sensors based on relevant cross-modal information between the first sensor and the second sensor.

10. The apparatus of claim 7, wherein to fuse the set of attended features, the at least one processor, individually or in any combination, is configured to:
fuse the set of attended features with a multilayer perceptron (MLP) to integrate information across the multiple sensors.

11. The apparatus of claim 7, wherein to output the concatenated sets of features and the corresponding embedded vectors for the training of the ML model, the at least one processor, individually or in any combination, is configured to:
output the fused set of attended features for the training of the ML model.

12. The apparatus of claim 1, wherein the at least one processor, individually or in any combination, is further configured to:
output an indication of the trained ML model.

13. The apparatus of claim 12, wherein to output the indication of the trained ML model, the at least one processor, individually or in any combination, is configured to:
transmit the indication of the trained ML model; or
store the indication of the trained ML model.

14. A method of data processing, comprising:
extracting a set of features from each sensor of multiple sensors;
mapping a vector to each feature in the set of features extracted from each sensor, wherein the vector is related to at least one of: positioning information or a set of intrinsic parameters associated with each sensor of the multiple sensors;
concatenating sets of features from the multiple sensors with their corresponding embedded vectors; and
training a machine learning (ML) model to identify relationships between different sensors in the multiple sensors based on the concatenated sets of features and the corresponding embedded vectors; or outputting the concatenated sets of features and the corresponding embedded vectors for training of the ML model for identification of the relationships between the different sensors in the multiple sensors.

15. The method of claim 14, wherein mapping the vector to each feature in the set of features extracted from each sensor comprises:
embedding the vector into each feature in the set of features extracted from each sensor.

16. The method of claim 15, wherein the multiple sensors include different types of sensors, and wherein vectors mapped to features extracted from the different types of sensors are associated with different embedding dimensions.

17. The method of claim 14, further comprising:
applying an attention mechanism to the concatenated sets of features to obtain a set of attended features associated with the multiple sensors; and
fusing the set of attended features.

18. The method of claim 17, wherein training the ML model to identify the relationships between the different sensors in the multiple sensors based on the concatenated sets of features and the corresponding embedded vectors comprises:
training the ML model to identify the relationships between the different sensors in the multiple sensors based on the fused set of attended features.

19. The method of claim 17, wherein applying the attention mechanism to the concatenated sets of features to obtain the set of attended features associated with the multiple sensors comprises:
attending to a first subset of concatenated features in the sets of concatenated features that is associated with a first sensor in the multiple sensors over a second subset of concatenated features in the sets of concatenated features that is associated with a second sensor in the multiple sensors based on relevant cross-modal information between the first sensor and the second sensor.

20. A computer-readable medium storing computer executable code, the code when executed by at least one processor causes the at least one processor to:
extract a set of features from each sensor of multiple sensors;
map a vector to each feature in the set of features extracted from each sensor, wherein the vector is related to at least one of: positioning information or a set of intrinsic parameters associated with each sensor of the multiple sensors;
concatenate sets of features from the multiple sensors with their corresponding embedded vectors; and
train a machine learning (ML) model to identify relationships between different sensors in the multiple sensors based on the concatenated sets of features and the corresponding embedded vectors; or output the concatenated sets of features and the corresponding embedded vectors for training of the ML model for identification of the relationships between the different sensors in the multiple sensors.
